(19) United States
(12) Patent Application Publication
(10) Pub. No.: US 2026/0370084 A1
(43) Pub. Date: Nov. 19, 2026

(54) ADAPTER SHAFT

(71) Applicant: SEW-EURODRIVE GMBH & CO. KG, Bruchsal (DE)

(72) Inventors: Markus WÖPPERMANN, Karlsbad (DE); Sascha HALLER, Karlsruhe (DE)

(73) Assignee: SEW-EURODRIVE GMBH & CO. KG, Bruchsal (DE)

(21) Appl. No.: 19/478,340

(22) PCT Filed: Mar. 6, 2024
(86) PCT No.: PCT/EP2024/055850

§ 371 Date: Oct. 24, 2025

(30) Foreign Application Priority Data
Apr. 24, 2023 (DE) 102023001616.0

(51) Int. Cl. H02K 7/00; F16D 1/04; H02K 7/116

(52) U.S. Cl. CPC H02K 7/003; F16D 1/04; H02K 7/116

(57) ABSTRACT

A gear motor includes a shaft, an adapter shaft, and a toothing part. The adapter shaft is hollow, the adapter shaft has a clamping region and a connection region, and the shaft is inserted in the clamping region. The toothing part has a running toothing and a pin axially adjacent to the running toothing or axially spaced from the running toothing, the pin having an external toothing, e.g., a knurl toothing. The pin is connected to the adapter shaft in a form-fitting manner, and the adapter shaft has a half-slot that extends in the circumferential direction over a circumferential angle, which equals between 90° and 270°. The half-slot is formed to extend through the adapter shaft in the radial direction.

### FIELD OF THE INVENTION

The present invention relates to an adapter shaft.

### BACKGROUND INFORMATION

In certain conventional systems, a gear motor has a gearbox that is driven by an electric motor.

A shaft having a pinion is described in Japanese Patent Document No. 2014-1835.

A flexible shaft coupling is described in German Patent Document No. 10 2004 063 562.

A method for connecting a hub to a shaft is described in German Patent Document No. 100 03 923.

A radial clamping hub is described in German Patent Document No. 101 55 581.

### SUMMARY

Example embodiments of the present invention provide a connection of the electric motor of the gear motor to the gearbox of the gear motor, in which the gear motor is compact in its configuration.

According to example embodiments, an adapter shaft is adapted, e.g., configured, for force-locking connection with a shaft, the adapter shaft is hollow, the adapter shaft has a clamping region and a connection region, the shaft is inserted in the clamping region, e.g., projects through the clamping region, and is connected to the clamping region in a force-locking manner, and the clamping region has an axial slot. For example, the normal of the slot plane of the axial slot is oriented in a tangential direction relative to the axis of rotation of the adapter shaft. The adapter shaft has a half-slot, the normal of the slot plane of the half-slot is oriented parallel to the axial direction, i.e., for example, is oriented parallel to the axis of rotation of the adapter shaft, and the first slot end of the half-slot in the circumferential direction is curved, e.g., such that the circumferential angular position of the first slot end increases monotonically, e.g., strictly monotonically, with increasing radial distance, e.g., so that the circumferential angular region covered by the half-slot is formed to increase monotonically, e.g., strictly monotonically, with increasing radial distance. For example, the half-slot extends in the circumferential direction over a circumferential angle, the amount of which is between 90° and 270°. For example, the half-slot is formed to extend through the adapter shaft in the radial direction, e.g., at the circumferential angle positions covered by the half-slot in the circumferential direction. For example, the radial direction is related to the axis of rotation of the shaft, and the circumferential direction is also related to the axis of rotation of the shaft.

An advantage of this is that the adapter shaft has a higher load capacity via the curved configuration of the first slot end and is thus able to transmit higher torques. It is important that the first slot end is spaced from the axial slot in the circumferential direction, whereas the second slot end of the half-slot is adjacent to the axial slot or at least less spaced from the axial slot than the first slot end of the half-slot.

The clamping region thus merges, in the region of the adapter shaft adjacent to and/or adjoining the first slot end, into the connecting region, or adjoins the connecting region.

For example, the first slot end is formed to be curved in the shape of a circular arc. Alternatively, to achieve an even higher load-bearing capacity of the adapter shaft, the first slot end is formed to be curved in the shape of an ellipse or curved in the shape of a tangent.

According to example embodiments, the other end of the half-slot, e.g., in the circumferential direction, is formed in a straight line, e.g., in the radial direction, and/or has a single circumferential angular position. An advantage of this is that the load-bearing capacity remains high and the straight slot end is readily implemented.

According to example embodiments, the half-slot is arranged axially between the clamping region and the connection region. An advantage of this is that the elasticity of the clamping region is improved and the adapter shaft can still be arranged in one part.

According to example embodiments, a gear motor includes the shaft, e. g., the rotor shaft, the adapter shaft, and a toothing part, e. g., a sun gear. The adapter shaft is hollow, the adapter shaft has a clamping region and a connection region, the shaft is inserted in the clamping region, e. g., projects through the clamping region, and is connected to the clamping region in a force-locking manner, and the toothing part has a running toothing, e.g., involute toothing, and a pin axially adjacent to the running toothing or axially spaced from the running toothing, the pin having an external toothing, e.g., a knurl toothing. The pin is connected to the adapter shaft in a form-fitting manner, e.g., by the external toothing being cut into the adapter shaft, the adapter shaft has a half-slot that extends in the circumferential direction over a circumferential angle, which equals between 90° and 270°, and the half-slot is formed to extend through the adapter shaft in the radial direction. For example, the radial direction is related to the axis of rotation of the shaft, and the circumferential direction is also related to the axis of rotation of the shaft.

An advantage of this is that the half-slot separates the clamping region from the connection region, thus facilitating elastic deformation of the clamping region. In addition, the normal direction of the slot plane of the half-slot is oriented parallel to the axial direction. The shaft thus projects through the clamping region into the connection region. In the connection region, the adapter shaft can be centered in relation to the shaft, and in the clamping region, a force-locking connection can be made to transmit the torque of the shaft to the adapter shaft, which transmits this torque to the sun gear via the pin of the sun gear.

The advantage of the arrangement described herein is a compact configuration in that the force-locking connection on the adapter shaft is formed in one part. This is because the clamping region of the adapter shaft is formed in one part with the connection region. A separate clamping ring is thus not necessary.

In addition, the gear motor can be configured to be compact because the sun gear of the planetary gear unit is inserted directly into the adapter shaft, into which the rotor shaft of the electric motor is also inserted as a shaft. The axis of rotation of the sun gear and the rotor shaft are thus oriented coaxially to each other. For example, the shaft and the rotor shaft have only a slight axial distance from each other, so that the gear motor can be arranged compactly.

According to example embodiments, the adapter shaft has a stepped bore, which has a first region in the axial direction in front of the step of the stepped bore and a second region in the axial direction behind the step, and the pin of the sun gear is received in the second region. For example, the clear internal diameter of the first region is greater than the clear internal diameter of the second region. The shaft projects into the first region. An advantage of this is that the pin is axially spaced from the shaft.

According to example embodiments, the running toothing of the sun gear is axially spaced from the region covered by the pin in the axial direction. For example, the running toothing is in engagement with the respective toothing of planet gears which are arranged rotatably mounted in a planet carrier arranged as an output shaft and are in engagement with a ring gear connected for conjoint rotation with the housing part of the gearbox. An advantage of this is that the sun gear can be connected with its pin to the adapter shaft and with its running toothing transmits the torque to the planet gears.

According to example embodiments, the inner ring of a bearing is plugged onto the adapter shaft, and the outer ring of the bearing is received in an adapter housing of the gear motor. For example, the bearing is a roller bearing. An advantage of this is that the adapter shaft is rotatably mounted via the bearing and thus the sun gear is mounted via the adapter shaft, which in addition is supported via the shaft.

According to example embodiments, the region covered by the pin or its external toothing in the axial direction is comprised by, or includes, the region covered by the second region in the axial direction. An advantage of this is that the pin is received in a form-fitting manner in the adapter shaft. For example, the external toothing of the pin is cut into the adapter shaft and thus connected very rigidly. In addition, a high torque can be transmitted.

According to example embodiments, the region covered by the bearing in the axial direction overlaps with the region covered by the second region in the axial direction. An advantage of this is that the pin is received in the second region and the bearing is also plugged on in the same axial region. Thus, high forces can be introduced in this corresponding axial region of the adapter shaft, for which purpose the adapter shaft also has an increased wall thickness in this region.

According to example embodiments, the axial position of the step of the stepped bore is comprised by, or includes, the region covered by the bearing in the axial direction. An advantage of this is that although the step creates a notch effect, the bearing reinforces the adapter shaft in the corresponding axial region.

According to example embodiments, the radial wall thickness of the adapter shaft in the region covered by the second region in the axial direction is greater than the radial wall thickness of the adapter shaft in the region of the adapter shaft adjacent to the second region. An advantage of this is that forces can be introduced into the thickened section of the connection region from the sun gear on the one hand and from the bearing on the other.

According to example embodiments, the radial wall thickness of the adapter shaft in the region covered by the second region in the axial direction is greater than the radial wall thickness in the remaining section of the connection region. An advantage of this is that forces can be introduced into the thickened section of the connection region from the sun gear on the one hand and from the bearing on the other.

According to example embodiments, the axial width of the half-slot is at least five times smaller than the clear internal diameter of the first region and/or the external diameter of the shaft in the region covered by the clamping region in the axial direction. An advantage of this is that the half-slot is narrow and thus the gear motor can be arranged compactly.

According to example embodiments, three axially oriented bores, e. g., blind bores, are provided in the clamping region. For example, the bore axis of each of the three bores is oriented parallel to the axis of rotation of the shaft. For example, the three bores are each arranged as blind bores introduced from the axial end face of the clamping region and, for example, all three are arranged at the same radial distance. For example, the middle one of the three bores in the circumferential direction has a smaller distance, e.g., circumferential angular distance, to a second of the three bores than to the third of the three bores. For example, one of the three bores is arranged as a balancing of the half-slot. An advantage of this is that it is possible to balance the half-slot and the axial slot.

According to example embodiments, the clamping region has an axial slot extending through the clamping region in the axial direction and in the radial direction, through which axial slot a clamping screw projects. An advantage of this is that the clamping region can be shrunk onto the shaft to produce the force-locking connection.

According to example embodiments, the screw head of the clamping screw rests against a step of the clamping region, and step is arranged in the clamping region on the first side of the axial slot. On the other side, e.g., the second side, of the axial slot, the clamping region has a threaded region through which the clamping screw projects and into which the clamping screw is screwed. An advantage of this is that a clamping ring is integrated into the adapter shaft.

According to example embodiments, a limiting device, e.g., a bolt, is fastened in the clamping region and projects out of the clamping region, and the limiting device limits the screw head in the direction of the screw axis and/or the limiting device rests against the side of the screw head facing away from the threaded region, e.g., for spreading open the axial slot. The clamping screw, e.g., on the side of the threaded region facing away from the screw head of the clamping screw and/or in the region of the clamping screw, which region projects from the clamping region and, for example, faces away from the axial slot, has an annular groove in which a securing ring is arranged in a form-fitting manner, e. g., snapped in, e.g., for limiting the spreading open of the axial slot. An advantage of this is that the axial slot can be spread open and a limitation on the spreading is provided to protect the adapter shaft.

According to example embodiments, the axial slot opens into the half-slot, and the circumferential angular region covered by the axial slot in the circumferential direction is contained in the circumferential angular region covered by the half-slot in the circumferential direction. For example, the circumferential angular region covered by the axial slot in the circumferential direction is spaced on both sides in the circumferential direction from the ends of the circumferential angular region covered by the half-slot in the circumferential direction. For example, the slot plane of the axial slot is oriented perpendicular to the slot plane of the half-slot. An advantage of this is that the clamping region of the adapter shaft is sufficiently elastic. In addition, failure of the adapter shaft is prevented, as the axial slot does not open into the half-slot at the end of the half-slot, but at a distance in the circumferential direction, thus allowing for a reduced notch effect in the area surrounding the opening region.

According to example embodiments, the region covered by the shaft in the axial direction overlaps with the region covered by the bearing in the axial direction. For example, the shaft is received in the first region, e.g., in the region covered by the bearing in the axial direction, with a precise fit and/or without play. An advantage of this is that the shaft supports the adapter shaft from the radial inside and thus stiffens the bearing mounting region of the adapter shaft, which region also surrounds the pin of the sun gear.

According to example embodiments, the pin is axially spaced from the first region. An advantage of this is that the sun gear does not project into the first region of the blind bore, e.g., the wider region of the blind bore, and thus leaves sufficient space for the shaft to project as close as possible to the bearing in the axial direction and thus to stabilize and stiffen the adapter shaft from the inside.

Further features and aspects of example embodiments of the present invention are explained in more detail below with reference to the appended schematic Figures.

### BRIEF DESCRIPTION OF THE DRAWINGS

FIG. 1 is a perspective view of an adapter shaft 1 of a gear motor.

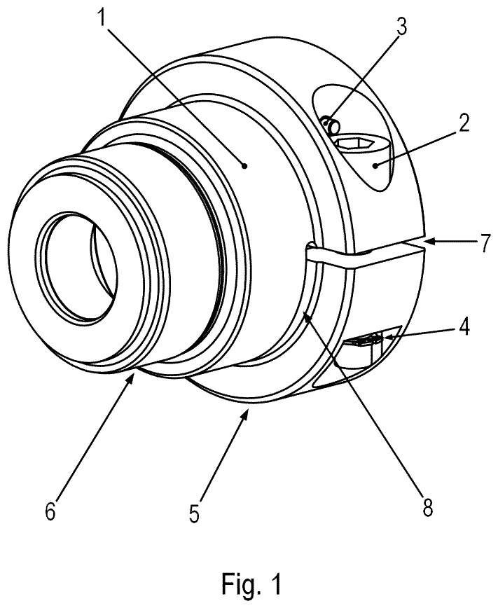

FIG. 2 is a cross-sectional view of the adapter shaft 1.

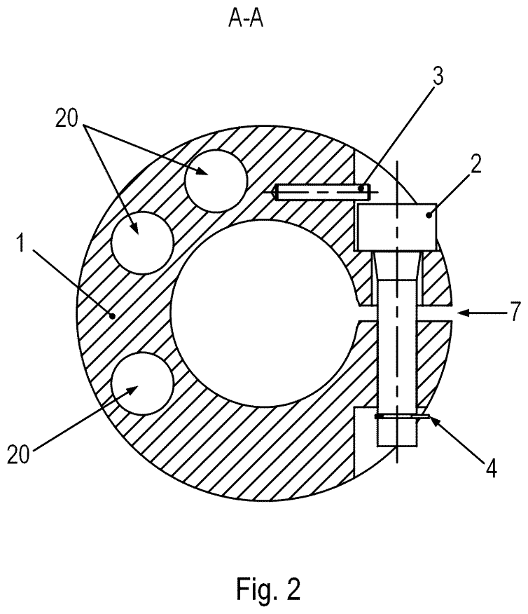

FIG. 3 is a side view of the adapter shaft 1.

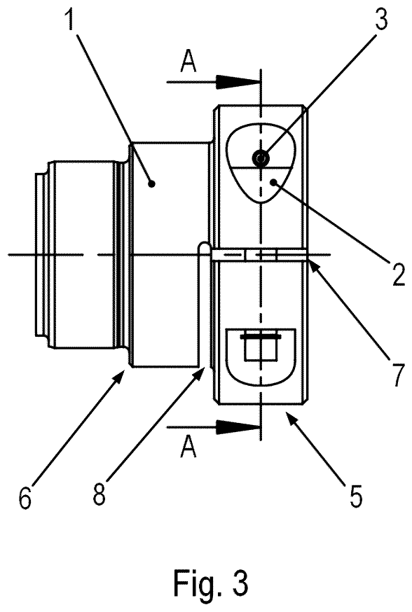

FIG. 4 is a cross-sectional view of the planetary gear unit.

FIG. 5 is a top view of the planetary gear unit.

FIG. 6 is a further perspective view of the adapter shaft 1, in which an angled groove 60 provided in the clamping region 5 is visible.

FIG. 7 is a cross-sectional view through the adapter shaft 1, in which the cross-sectional plane of the cross section bisects a half-slot 8 of the adapter shaft 1.

### DETAILED DESCRIPTION

As illustrated in the Figures, the adapter shaft 1 has a clamping region 5, which is separated from a connection region 6 via the half-slot 8, i.e., a radially oriented half-through slot. The normal of the slot plane of the half-slot 8 is oriented parallel to the axial direction, i.e., for example, is oriented parallel to the axis of rotation of the adapter shaft 1.

The adapter shaft 1, together with its annular clamping region 5 and its bushing-shaped connection region 6, is formed as a single piece, e. g., as a single part.

A shaft, e.g., the rotor shaft of an electric motor of the gear motor, can be inserted into the clamping region 5 and connected in a force-locking manner by actuating a clamping screw 2.

The pin section of a sun gear of a planetary gear unit of the gear motor, which pin section is, for example, toothed with a knurl toothing, can be inserted into the connection region 6 and thus connected in a form-fitting manner. In this manner, the adapter shaft 1 can be used as a coupling between the input rotor shaft and the sun gear 42.

The clamping region has an axial slot extending through the clamping region 5 in the axial direction and in the radial direction, through which axial slot the clamping screw 2 projects.

The screw head of the clamping screw 2 rests against a step arranged in the clamping region 5 on the first side of the axial slot.

On the other side of the axial slot, the clamping region has a threaded region through which the clamping screw 2 projects and into which the clamping screw 2 is screwed.

A securing ring 4 is arranged in the region of the clamping screw 2, which region projects from the threaded region, which securing ring 4 is snapped into an annular groove of the clamping screw 2 and thus acts as a limitation on the spreading.

This is because a bolt 3, which is inserted into a bore of the clamping region, the bore axis of which is oriented perpendicular to the screw axis of the clamping screw 2, serves as a limitation for the screw head of the clamping screw 2. Thus, when the clamping screw 2 is unscrewed from the threaded region, the screw head is prevented from moving out of the bolt 3 and thus the axial slot is widened until the securing ring 4 rests against the clamping region and prevents further expansion. This prevents destruction of the clamping region.

The screw head of the clamping screw 2, for example, has an internal hexagon, so that the clamping screw 2 can be readily actuated with an external hexagon tool.

In addition, three axially oriented bores 20 are provided in the clamping region, which are provided for balancing the adapter shaft 1.

The three bores 20 are each arranged as blind bores introduced from the axial end face of the clamping region and, for example, all three are arranged at the same radial distance.

The middle one of the three bores 20 in the circumferential direction has a smaller distance, e.g., circumferential angle distance, to a second one of the three bores 20 than to the third one of the three bores 20.

By selecting a number of three bores 20, one of the three bores can be provided for balancing the radially directed half-through half-slot.

The axial direction is parallel to the axis of rotation of the shaft and/or the sun gear 42. The radial direction, the respective radial distance, and the circumferential direction are also each related to the axis of rotation of the shaft and/or the sun gear 42.

The screw axis of the clamping screw 2 is oriented perpendicular to the axis of rotation of the shaft and/or the sun gear 42. In addition, the bore axis of the bore receiving the bolt 3 is also oriented perpendicular to the axis of rotation of the shaft and/or the sun gear 42.

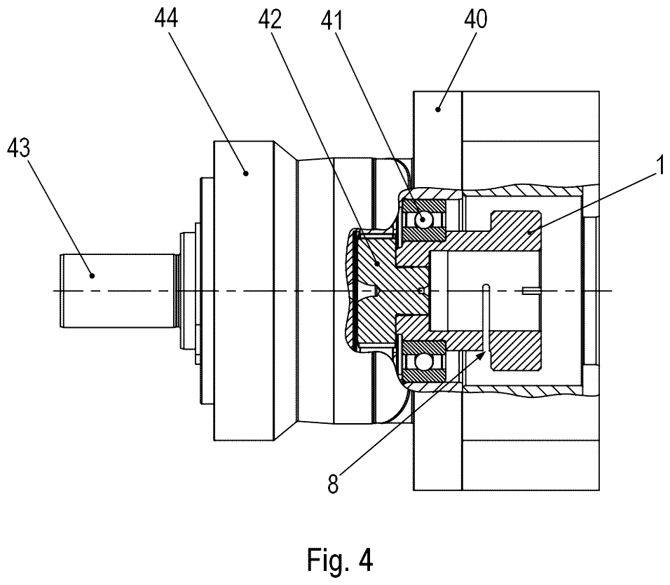

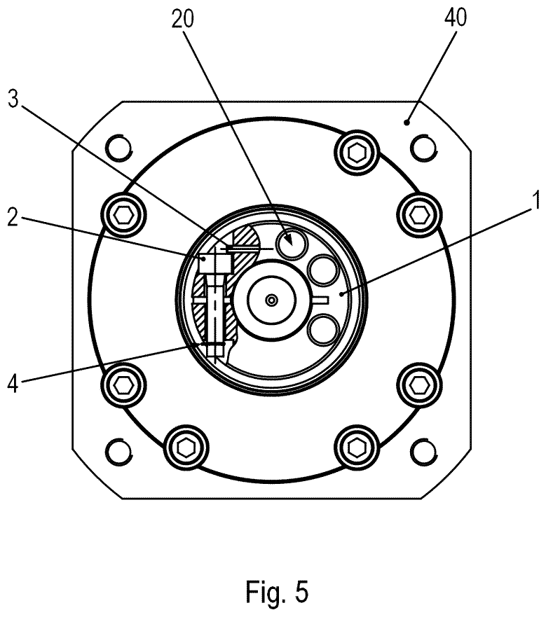

As illustrated in FIGS. 4 and 5, the gearbox of the gear motor has a housing part 44 which is connected to an adapter housing 40 to which a bearing flange of the electric motor of the gear motor can be connected, and the bearing flange is connected to a stator housing of the electric motor.

A bearing of the rotor shaft of the electric motor is received in the bearing flange, and the rotor shaft can be pushed into the hollow region of the clamping region and can be connected in a force-locking manner via actuating the clamping screw 2.

For this purpose, the adapter shaft 1 is hollow and has an axially extending blind bore. For receiving the rotor shaft, the blind bore has a first axial region arranged axially in front of a step of the blind bore. The clear diameter of the first axial region of the blind bore is larger than the clear diameter of the second region arranged axially behind the step of the blind bore.

The sun gear 42 is inserted with its externally toothed pin into the second region of the adapter shaft, and the external toothing of the pin is cut into the material of the adapter shaft, e.g., in the second region.

A bearing 41 is pushed onto the adapter shaft 1 and is received in the adapter housing 40. For example, the bearing 41 is positioned against a step on the outer surface of the adapter shaft 1.

The region covered by the bearing 41 in the axial direction includes the region covered by the second region in the axial direction and/or the region covered by the pin of the sun gear 42 in the axial direction.

The region covered by the bearing 41 in the axial direction overlaps with the region covered by the first region in the axial direction.

The region covered by the first region in the axial direction includes the region covered by the clamping region 5 in the axial direction and overlaps with the region covered by the connection region 6 in the axial direction.

The rotor shaft projects so deeply into the first region in the axial direction that the region covered by the rotor shaft in the axial direction includes the axial region covered by the half-slot and the region covered by the clamping region 5 in the axial direction.

The running toothing of the sun gear 42, which running toothing is axially spaced from the pin region, is in engagement with the toothing of planet gears, which are also in engagement with the inner toothing of a ring gear, which is connected for conjoint rotation with the housing part 44. The planet gears are rotatably mounted on a planet carrier, which itself is rotatably mounted relative to the housing part 22 and is arranged as the output shaft 43 of the planetary gear unit of the gear motor.

In the axial direction, the bores 20 are spaced from the second region. Accordingly, the clamping region 5 is also spaced from the second region in the axial direction.

The step of the stepped bore is arranged in the region covered by the bearing in the axial direction. In this manner, a greater wall thickness can be achieved in the region covered axially by the first region than in the remaining connection region 6. The receiving of the sun gear 42 and the bearing can thus be implemented in a very solid region of the adapter shaft 1. This region of the bearing seat and the mounting of the sun gear 42 is thus very rigid, whereas the transition to the clamping region is more elastic, e.g., due to the half-slot.

The half-slot extends by 180° in the circumferential direction and passes completely through the hollow adapter shaft 1 in the radial direction. For example, the axial width of the half-slot differs from the slot width of the axial slot by a maximum of 50%.

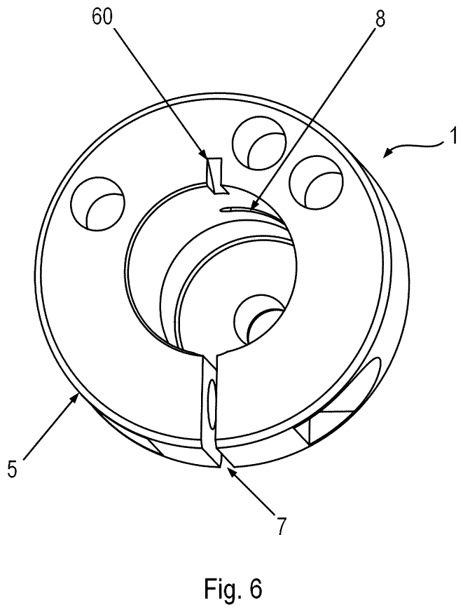

As illustrated in FIG. 6, the angled groove 60 arranged diametrically to the axial slot of the clamping region 5 narrows the clamping region 5 and thus increases its elasticity. For example, the inclined groove 60 cuts through one edge of the clamping region 5 and is located between two of the bores 20 in the circumferential direction. For example, the angled groove 60, depending on its dimensions, i.e., groove depth, can contribute to the balancing of the adapter shaft 1, e.g., as it is not formed in an axially extending manner.

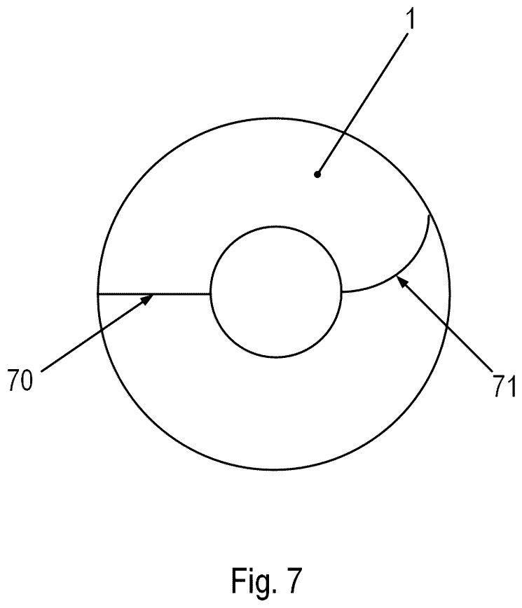

As illustrated in FIG. 7, the half-slot 8 has a first slot end 71 at its first end in the circumferential direction, which slot end 71 is curved, and a second slot end 70 at its other end, which slot end 70 is formed in a straight line, i.e., for example, not curved.

The second slot end 70 is thus purely radially oriented. As the radial distance increases, the second slot end 70 always has the same constant circumferential angle position.

The first slot end 71, on the other hand, has a circumferential angle that increases monotonically, e.g., strictly monotonically, with increasing radial distance. Thus, the circumferential angular region covered by the half-slot 8 increases monotonically, e.g., strictly monotonically, with increasing radial distance. In this manner, the adapter shaft has a higher load capacity and, for example, higher forces can be transmitted.

Since the adapter shaft 1 is hollow, the half-slot 8 is thus limited by the slot end (70, 71) arranged at the front in the circumferential direction and the rear slot end (70, 71) arranged at the other end of the half-slot 8.

The curved course of the first slot end 71 is, for example, formed in the shape of a circular arc. Alternatively, a tangent-shaped or elliptical course can also be provided, as such a course provides for an even higher load-bearing capacity compared to a circular arc-shaped course.

The normal of the slot plane of the axial slot 7 is oriented parallel to a tangential direction and/or oriented perpendicular to the normal of the slot plane of the half-slot 8.

However, the angled groove 60 is not formed to extend axially, but that the region covered by the angled groove 60 in the axial direction is shorter than the region covered by the clamping region 5 in the axial direction, which region includes the region covered by the angled groove 60 in the axial direction.

According to example embodiments, the step of the stepped bore is arranged axially centrally in the region covered by the bearing 41 in the axial direction. Thus, increased stability is achieved.

### LIST OF REFERENCE NUMERALS

1 Adapter shaft
2 Clamping screw
3 Bolt
4 Securing ring
5 Clamping region
6 Connection region
7 Axial slot
8 Half-slot
20 Bore
40 Adapter housing
41 Bearing
42 Sun gear
43 Output shaft, planet carrier
44 Housing part
60 Angled groove
70 Second slot end
71 First slot end

1-15. (canceled)

16. An adapter shaft, comprising:
a clamping region having an axial slot;
a connection region;
wherein the adapter shaft is hollow, and the clamping region is adapted to receive a shaft;
wherein the adapter shaft includes a half-slot, a normal of a slot plane of the half-slot is oriented parallel to an axial direction; and
wherein a first slot end of the half-slot in a circumferential direction is curved.

17. The adapter shaft according to claim 16, wherein the shaft projects through the clamping region and is connected to the clamping region in a force-locking manner.

18. The adapter shaft according to claim 16, wherein a normal of a slot plane of the axial slot is oriented in a tangential direction relative to an axis of rotation of the adapter shaft.

19. The adapter shaft according to claim 16, wherein a circumferential angular position of the first slot end increases monotonically and/or strictly monotonically with increasing radial distance so that a circumferential angular region covered by the half-slot increases monotonically and/or strictly monotonically with increasing radial distance, the half-slot extends in the circumferential direction over a circumferential angle between 90° and 270°, the half-slot extends through the adapter shaft in a radial direction and/or at circumferential angle positions covered by the half-slot in the circumferential direction, the radial direction is related to an axis of rotation of the shaft, and the circumferential direction is also related to the axis of rotation of the shaft.

20. The adapter shaft according to claim 16, wherein a second end of the half-slot is arranged in a straight line, is arranged in a radial direction, and/or has a single circumferential angular position.

21. The adapter shaft according to claim 16, wherein the half-slot is arranged axially between the clamping region and the connection region.

22. A gear motor, comprising:
an adapter shaft as recited in claim 16;
the shaft; and
a toothing part including a running toothing and a pin axially adjacent to the running toothing or axially spaced from the running toothing, the pin including an external toothing;
wherein the pin is connected to the adapter shaft in a form-fitting manner.

23. The gear motor according to claim 22, wherein the toothing part includes a sun gear, and the shaft includes a rotor shaft of the gear motor.

24. The gear motor according to claim 22, wherein the external toothing cuts into the adapter shaft; and/or
wherein the adapter shaft includes a stepped bore having a first region in an axial direction in front of a step of the stepped bore and a second region in the axial direction behind the step, the pin being received in the second region, and the shaft projects into the first region.

25. The gear motor according to claim 24, wherein a clear internal diameter of the first region is greater than a clear internal diameter of the second region.

26. The gear motor according to claim 22, wherein the running toothing is axially spaced from a region covered by the pin in an axial direction and/or the running toothing is in engagement with a respective toothing of planet gears that are arranged rotatably mounted in a planet carrier arranged as an output shaft and are in engagement with a ring gear connected for conjoint rotation with a housing part of a gearbox of the gear motor.

27. The gear motor according to claim 22, wherein an inner ring of a bearing is arranged on the adapter shaft, and an outer ring of the bearing is arranged in an adapter housing of the gear motor.

28. The gear motor according to claim 24, wherein a region covered by the pin and/or the external toothing of the pin in an axial direction includes a region covered by the second region in the axial direction.

29. The gear motor according to claim 24, wherein an inner ring of a bearing is arranged on the adapter shaft, and an outer ring of the bearing is arranged in an adapter housing of the gear motor; and
wherein a region covered by the bearing in the axial direction overlaps with a region covered by the second region in the axial direction and/or an axial position of the step of the stepped bore includes the region covered by the bearing in the axial direction.

30. The gear motor according to claim 24, wherein a radial wall thickness of the adapter shaft in a region covered by the second region in the axial direction is greater than a radial wall thickness of the adapter shaft in a region of the adapter shaft adjacent to the second region, the radial wall thickness of the adapter shaft in the region covered by the second region in the axial direction is greater than a radial wall thickness in a remaining section of the connection region, and/or an axial width of the half-slot is at least five times smaller than a clear internal diameter of the first region and/or an external diameter of the shaft in a region covered by the clamping region in the axial direction.

31. The gear motor according to claim 22, wherein three axially oriented bores are arranged in the clamping region, a bore axis of each bore is oriented parallel to an axis of rotation of the shaft, each bore is arranged as a blind bore open in an axial end face of the clamping region, all three bores are arranged at a same radial distance, a middle one of the bores in a circumferential direction has a smaller distance to a second one of the bores than to a third one of the bores, and/or one of the bores is adapted to balance the half-slot.

32. The gear motor according to claim 22, wherein the clamping region includes an axial slot extending through the clamping region in an axial direction and in a radial direction, through which axial slot a clamping screw projects.

33. The gear motor according to claim 32, wherein a screw head of the clamping screw rests against a step of the clamping region arranged in the clamping region on a first side of the axial slot, and, on a second side of the axial slot, the clamping region has a threaded region through which the clamping screw projects and into which the clamping screw is screwed.

34. The gear motor according to claim 33, wherein a limiting device is fastened in the clamping region and projects out of the clamping region, the limiting element is adapted to limit a screw head in a direction of a screw axis and/or the limiting device rests against a side of the screw head facing away from the threaded region, the clamping screw includes an annular groove in which a securing ring is arranged in a form-fitting manner.

35. The gear motor according to claim 22, wherein the axial slot opens into the half-slot, and a circumferential angular region covered by the axial slot in a circumferential direction is contained in a circumferential angular region covered by the half-slot in the circumferential direction, the circumferential angular region covered by the axial slot in the circumferential direction is spaced on both sides in the circumferential direction from ends of the circumferential angular region covered by the half-slot in the circumferential direction, and a slot plane of the axial slot is oriented perpendicular to a slot plane of the half-slot.

36. The gear motor according to claim 22, wherein an angled groove is arranged in the clamping region, the angled groove is spaced 180° from the axial slot in the circumferential direction, and a region covered by the angled groove in an axial direction is contained within a region covered by the clamping region in the axial direction.

37. The gear motor according to claim 27, wherein a region covered by the shaft in an axial direction overlaps with a region covered by the bearing in the axial direction.

38. The gear motor according to claim 24, wherein the shaft is arranged in the first region without play, and/or the pin is axially spaced from the first region.
